(19) United States
(12) Patent Application Publication
(10) Pub. No.: US 2024/0055624 A1
(43) Pub. Date: Feb. 15, 2024

(54) FUEL CELL SYSTEM HAVING IMPROVED HUMIDIFICATION

(71) Applicant: Robert Bosch GmbH, Stuttgart (DE)

(72) Inventor: Jochen Braun, Heimsheim (DE)

(21) Appl. No.: 18/261,038

(22) PCT Filed: Dec. 16, 2021
(86) PCT No.: PCT/EP2021/086153

§ 371 Date: Jul. 11, 2023

(30) Foreign Application Priority Data
Jan. 11, 2021 (DE) 10 2021 200 151.3

(51) Int. Cl. H01M 8/04119; H01M 8/04082; H01M 8/04492; H01M 8/04746; H01M 8/04828

(52) U.S. Cl. CPC H01M 8/04126; H01M 8/04201; H01M 8/04507; H01M 8/04753; H01M 8/04835

(57) ABSTRACT

The invention relates to a fuel cell system, having at least one fuel cell with an anode, a cathode, a membrane arranged between the anode and the cathode, a cathode inlet, a cathode outlet, an anode inlet, and an anode outlet. According to the invention, the fuel cell system is characterized in that the fuel cell system is designed to at least partly conduct water accumulating on the anode outlet at least partially to at least one humidification connection in an oxidant line connected to the cathode inlet so that an oxidant flow flowing to the cathode inlet is humidified.

### BACKGROUND

The present invention relates to a fuel cell system having at least one fuel cell.

Vehicles are known in which electrical power is supplied by a fuel cell system, by which drive motors are powered. Hydrogen with an oxidant, typically oxygen from ambient air, is catalytically connected to water and electrical power is supplied. The ambient air is intended to be supplied to the fuel cell system by means of an air conveying system or air compression system. The hydrogen is usually stored in a high-pressure tank and fed to the fuel cell system via lines and valves. Furthermore, the hydrogen can be recirculated in an anode circuit or anode path.

Fuel cell systems based on PEM fuel cells require a sufficiently moist membrane to be able to conduct protons. Sufficient water management in the fuel cell system, especially in a cathode path and in the membrane is consequently essential for the operation of the fuel cell system. The risk of dehydration is significantly high, especially in the cathode entry area. It is known to operate fuel cell systems with membrane humidifiers and/or to provide higher system pressures for lower water absorption capacity of air. Internal humidification through flow ducts inside the individual fuel cells still requires quite high system pressures and a comparatively thin membrane. Therefore, in some operating ranges the fuel cell system cannot be operated or can only be operated with a reduction in power, e.g., at high ambient temperatures, when driving uphill, aged fuel cells, and the like.

### SUMMARY

Consequently, it is an object of the invention to propose a fuel cell or fuel cell system in which improved humidification is achieved in order to extend the feasible operating limits, while preferably not increasing, or significantly increasing, the complexity and cost of the fuel cell system used for this purpose.

Proposed is a fuel cell system having at least one fuel cell with an anode, a cathode, a membrane arranged between the anode and the cathode, a cathode inlet, a cathode outlet, an anode inlet, and an anode outlet. According to the invention, the fuel cell system is characterized in that it is designed to at least partly conduct water accumulating on the anode outlet to at least one humidification connection in an oxidant line connected to the cathode inlet so that an oxidant flow flowing to the cathode inlet is humidified.

Consequently, the at least one fuel cell is a polymer electrolyte membrane (PEM) fuel cell. The latter is supplied with hydrogen or a gas comprising hydrogen on the anode side and with oxygen or a gas containing oxygen on the cathode side. During operation, water also accumulates on the anode and is used according to the invention to humidify the oxidant flow.

The oxidant flow could be achieved in the form of air or oxygen. For vehicles operated on the ground or in the air, air could be particularly suitable as an oxidant, since it is available in sufficient quantities and can optionally be pressurized via a compressor.

The at least one humidification connection can comprise a single humidification connection, but it can also comprise multiple humidification connections. These can be provided at different points in the oxidant line. It is conceivable that a first humidification connection be arranged directly upstream of the cathode inlet. Said connection could also be directly upstream of a first dosing valve, which is connected to the cathode inlet and selectively dispenses water from the anode outlet. A second humidification connection could be downstream of an intercooler, and a third humidification connection could be upstream of an intercooler. A fourth humidification connection could be upstream of a compressor that delivers a pressurized oxidant flow into the oxidant line. Furthermore, a fifth humidification connection could also be located upstream of an air filter. Of course, other humidification connections are conceivable and it is conceivable that several humidification connections can also be used simultaneously.

The ordinal numbers “first,” “second,” “third,” “fourth,” and “fifth” used in the present disclosure are not to be understood as an order, but merely to identify like elements, which can, however, be provided in different places, for different purposes, or in different embodiments.

It is possible that, in a completed fuel cell system, a suitable humidification connection is selected that is suitable for an expected pressure at the anode outlet. For example, if this pressure is comparatively low, then a humidification connection upstream of a compressor might be more appropriate than a humidification connection downstream of a compressor.

The anode is often supplied with at least a slightly higher pressure than the cathode. Consequently, there is a positive pressure difference, i.e. an overpressure, between the anode outlet and the oxidant line directly upstream of the cathode inlet. According to the invention, this overpressure can be used to add water accumulating on the anode to the oxidant flow without special measures. Doing so enables significant savings in installation space and additionally required peripheral devices. This can significantly simplify the fuel cell system according to the invention compared to known fuel cell systems and enable a more cost-effective production process. Moreover, humidification of the oxidant flow does not cause any significant pressure loss in the supply air path. Furthermore, no membrane humidifier is required, so installation space can be saved. The operating range of the fuel cell system can be extended to operating limits, or a reduction in output expected due to the operating range can be significantly delayed. The power demands placed on a compressor within the fuel cell system can be lowered and/or the design of the at least one fuel cell at the full load point can be improved, as lowering a pressure demand and largely eliminating parasitic power from an air compression system reduces the overall power required. Consequently, the fuel cell system according to the invention is optimized with respect to the operating range and operating limits, and thus the hydrogen consumption, without significantly increasing the system costs for this purpose.

It is advantageous if a mixing unit for homogenizing an oxidant-water mixture is arranged downstream of the at least one humidification connection. The mixing unit enables homogenization of an oxidant-water mixture in order to avoid water droplets entering the at least one fuel cell. Furthermore, the mixing unit could promote vaporization/evaporation. The installation positions of the mixing unit could differ in several embodiments. For example, it is possible to arrange the mixing unit directly upstream of the cathode inlet or directly upstream of a shut-off valve. When a cathode bypass mentioned hereinafter is used, the mixing unit could be located upstream of a discharge point of the cathode bypass.

It is further advantageous if a porous humidifying body, through which the oxidant flow flows, is arranged downstream of the at least one humidification connection in order to promote the evaporation or vaporization of water. A pressure differential between the anode outlet and the relevant humidification connection may be too low to prevent atomization/misting of water into the oxidant line. By using the porous humidifying body, which is, e.g., sponge-like, the water wets a very large surface area, which facilitates evaporation or vaporization by the oxidant flow. In one preferred embodiment, the humidifying body could locally completely fill a cross-section of the oxidant line so that the oxidant flow must pass through the humidifying body.

In a further advantageous embodiment, a dosing unit is arranged upstream of the at least one humidification connection and is designed to dispense water in a dosed and pressurized manner into the at least one humidification connection. The dosing unit can enable fine atomization of the water by increasing the pressure. An increase in pressure can be achieved in several ways. For example, the dosing unit could have a pump-nozzle unit or the like. A pressure-increasing injector, e.g. featuring piezo actuators, would be conceivable. Likewise a small pump or a volumetrically conveying membrane pump. The latter variant would have the particular advantage that the pump stroke is precisely defined and a dosed quantity of water can be precisely measured. Low-cost and, in particular, ice-pressure resistant membrane pumps with a defined delivery volume or dosing volume are already available on the market for use in vehicles. The dosing unit could be used in combination with or instead of a dosing valve. The costs are manageable, especially when using said membrane pumps. The advantages of these pressure-increasing variants with atomization option are—compared to the aforementioned mixer—that no pressure loss is caused.

Further, the dosing unit and/or the at least one humidification connection could comprise a spraying or misting apparatus for spraying or misting the water. This apparatus supports the homogenization of the oxidant-water mixture. The spraying or misting apparatus can be in the form of an injector.

In a further advantageous embodiment, the dosing unit can be connected to a buffer storage means, in which water is at least temporarily collected. This can be a separate container that is constantly filled with water from the anode outlet. However, a discharge line connected to the anode outlet can also be designed such that an adequate buffer option for water is provided in that location. The dosing unit can then preferably be operated continuously, since it is continuously supplied by the buffer storage means, in which water has collected.

Particularly advantageously, a control unit could be coupled to at least one dosing valve or the aforementioned dosing unit and be designed to control an amount of water flowing into the oxidant line as a function of an operating condition of the at least one fuel cell. The control unit can achieve adaptation of the humidification. The dosing could be performed depending on the operating state or operating point of the fuel cell system, or the at least one fuel cell. If the at least one fuel cell is designed to be self-humidifying over a large portion of the operating range, then water could preferably be added at limits of the operating range to avoid performance degradation or dehydration in these limits. However, if the at least one fuel cell is designed such that a somewhat humidified oxidant can advantageously always be used, the humidification starting from water on the anode outlet could be applied over the entire operating range. It may still be necessary to adjust an operating strategy over the lifetime of the fuel cell system due to degradation of the at least one fuel cell. The addition could be adjusted accordingly over the lifetime of the product. For example, when the at least one fuel cell is new, the addition could only be performed at a few operating points and at an advanced service life in several sections of the operating range. The control unit could be designed to perform one or more of these operations.

In one advantageous embodiment, it is provided that a water supply detection unit is provided which is designed to detect or determine the amount of water flowing into the oxidant line. Knowing the amount of water flowing into the oxidant line is helpful in controlling the humidification by the humidification assembly accordingly. As an alternative to direct determination, the water quantity can be calculated via a model-based approach on the basis of available data/sensor data and control of the dosing unit. A flow-monitored actuator, e.g., in the dosing unit or a dosing valve could be evaluated by the flow characteristic during dosing or during a conveying stroke whether water or gas is dosed in. Large differences in the density of the fluids result in different flow characteristics in each case, which enable conclusions to be drawn about the media state (liquid or gaseous). For example, if there is no water to add, then feedback with this information could be considered in order to adjust an operating strategy. It is also possible to independently monitor the dosing of water by means of a suitable sensor.

It can be further advantageous if the fuel cell system is designed to increase a pressure differential between the anode and the cathode during a predetermined time interval and to conduct water into the at least one humidification connection during the time interval. Doing so is particularly useful when implementing the fuel cell system without a dosing unit, which could briefly increase the driving force acting on the water.

Further, a cathode bypass could be provided which is designed to selectively connect the cathode outlet to the oxidant line to discharge excess water into the exhaust air duct or directly to the environment. For this purpose, the cathode bypass can also go directly, i.e., past the stack, to the environment, or to the exhaust gas duct. If a corresponding dosing valve or the dosing unit or any other device for introducing water has a temperature below the freezing point or contains frozen water, then it can be thawed by warm air by incorporating it into a cathode bypass.

Further measures improving the invention are described in greater detail hereinafter in reference to the drawings, together with the description of the preferred exemplary embodiments of the invention.

### BRIEF DESCRIPTION OF THE DRAWINGS

Shown are:

FIG. 1 a schematic illustration of the fuel cell system.

FIGS. 2 and 3 a detailed representation of the water discharge.

### DETAILED DESCRIPTION

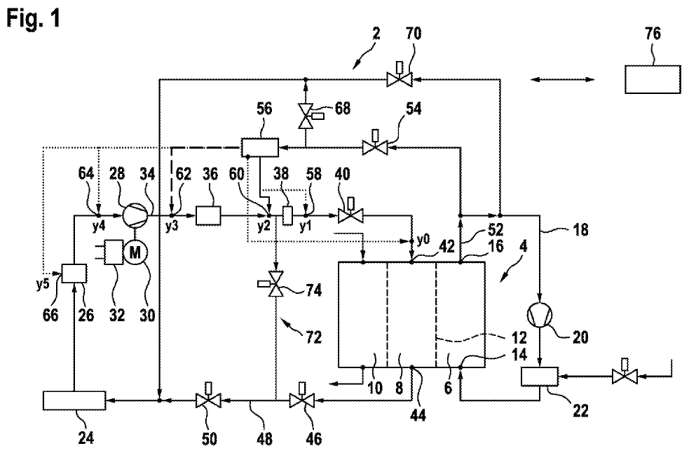

FIG. 1 shows a fuel cell system 2 in a schematic diagram. The fuel cell system 2 has a fuel cell 4, which has an anode 6, a cathode 8, and a cooling unit 10. A membrane 12 is arranged between the anode 6 and the cathode 8. The anode 6 is supplied with hydrogen via an anode inlet 14, which at least partially flows out again from an anode outlet 16. A recirculation line 18 recirculates hydrogen from the anode outlet 16 to the anode inlet 14 with the aid of a compressor 20 and a jet pump 22. Hydrogen from a hydrogen tank (not shown in this drawing) is added via jet pump 22.

Ambient air 24 is supplied to a compressor 28 via an air filter 26. The compressor is, e.g., driven by an electric motor 30, which is supplied with a voltage by an inverter 32. Pressurized air is thereby supplied to an oxidant line 34 designed as an air line.

Via an intercooler 36, cooled, pressurized air enters a mixing unit 38, which homogenizes an air-water mixture. The method of water discharge is further described hereinafter. For example, in the mixing unit 38, the water contained in the air is swirled to form minute droplets or a mist and to promote evaporation or vaporization of the water. Arranged downstream of the mixing unit 38 is a first shut-off valve 40, which is connected to a cathode inlet 42. Exhaust air from cathode 8 enters an exhaust air line 48 via a cathode outlet 44 through a second shut-off valve 46. The latter could comprise a control valve 50 that adds air back to the ambient air 24.

In this case, the air line 34 comprises a plurality of humidification connections, through which water can be supplied to the air flow from the anode outlet 16. Water is supplied in this case to a discharge line 52, which is connected to a dosing unit 56 (via a first dosing valve 54, by way of example). The dosing unit 56 could have a dosed amount of water from the discharge line 52 pressurized to a first humidification connection 58 directly upstream of the first shut-off valve s 40, or directly upstream of the mixing unit 38 into a second humidification connection 60. Similarly, a third humidification connection 62 could be located directly upstream of the intercooler 36. A fourth humidification connection 64 could be positioned directly upstream of compressor 28. Further, a fifth humidification connection 66 could be provided directly upstream of the air filter 26. Depending on the pressure differential between the anode outlet 16 and the cathode inlet 42, a humidification connection 58, 60, 62, 64 or 66 intended to be used can be selected. Several could also be used at the same time or depending on the operating status.

Humidification can be controlled by the first dosing valve 54 and/or the dosing unit 56. Excess water could be removed from the discharge line 52 via a second dosing valve 68 to be delivered to the ambient air 24 via the exhaust air line 48. The discharge line 52 could still be completely drained through this valve given the risk of frost. An anode purge valve 70 could be provided to remove purge gas from the anode 6 in order to reduce the nitrogen content in the anode circuit, and likewise to supply purge gas to ambient air 24. The discharge line 52 could be sized to have some storage capacity for water, thereby enabling it to be used as a buffer storage means. Consequently, reference sign 52 also applies to a buffer storage means.

A cathode bypass 72 with a bypass valve 74 can be provided to heat the air line 34 and components therein as needed to, e.g., heat the first shut-off valve 40 or the mixing unit 38.

A control unit 76 can further be provided for controlling the fuel cell system 2, which is connected to the valves 40, 46, 50, 54, 68 and 74 shown here, as well as the dosing unit 56, the inverter 32, and optional sensors (not shown in this drawing).

The dosing unit 56 could also be omitted. Then the discharge of water would be driven solely by the pressure differential present between the anode outlet 16 and the cathode inlet 42. The detail shown in FIG. 3 could be useful for this purpose.

The discharge of water into the air flow can be controlled by the control unit 32. In particular, the parameters of the air mass flow in the air line 34, the pressure in the cathode 8, the humidity state of the membrane 12, and the stoichiometry can be taken into account for this purpose. The dosing can be timed via the valve 54, whereby the duration of the injection or the number of strokes of a dosing pump and the frequency can be varied.

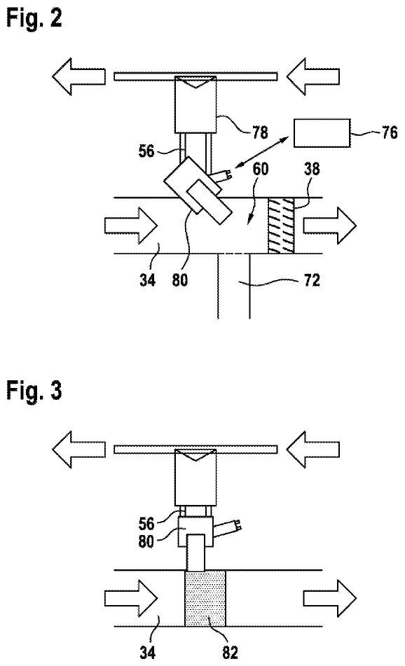

FIG. 2 shows a possible detail of the fuel cell system 2 according to the invention. Shown in this drawing is the discharge line 52, which is coupled to a buffer storage means 78. The latter feeds water to the dosing unit 56, which comprises an injector 80 that doses water into the air line 34. Doing so enables water to be sprayed in, so the injector 80 can be used as a spraying or misting apparatus. The second humidification connection 60, which is arranged upstream of the mixing unit 38, is selected as a suitable location for the addition. The water is introduced upstream of the cathode bypass 72. Doing so has the advantage that water which is not required for humidification can be fed into the exhaust air line 48 by briefly opening the cathode bypass 72 by opening the bypass valve 74, and a dosing valve 68 can be omitted in this case. Alternatively, the mixing unit 38 could be positioned downstream of the second humidification connection 60 and upstream of the cathode bypass 72. It would also be conceivable for the second dosing valve 68 to be diverted into the exhaust air line 48. In this case, the flexibility of the system 2 is higher, but would require the use of two active components, such as the two dosing valves 54 and 68, or the second dosing valve 68 and the dosing unit 56.

The injector 80 is electrically controlled and coupled to the control unit 76. Using a flow characteristic that changes directly from the water volume flow, the control unit 76 can detect or determine what the current water volume flow is. The pressure of the discharged water is thereby significantly increased.

Alternatively, a porous humidifying body 82 can be incorporated into the air line 34 instead, as shown schematically in FIG. 3. The humidifying body is supplied with water by the dosing unit 56, e.g. via a valve. A very large surface area is in that location cross-linked with water and evaporated or vaporized by the air flow. In this case, the water discharge is driven solely by the pressure differential existing between the anode outlet 16 and the cathode inlet 42.

1. A fuel cell system (2), having at least one fuel cell (4) with an anode (6), a cathode (8), a membrane (12) arranged between the anode (6) and the cathode (8), a cathode inlet (42), a cathode outlet (44), an anode inlet (14) and an anode outlet (16), wherein the fuel cell system (2) is configured to at least partly conduct water accumulating on the anode outlet (16) to at least one humidification connection (58, 60, 62, 64, 66) in an oxidant line (34) connected to the cathode inlet (42) so that an oxidant flow flowing to the cathode inlet (42) is humidified.

2. The fuel cell system (2) according to claim 1, wherein a mixing unit (38) for homogenizing an oxidant-water mixture is arranged downstream of the at least one humidification connection (58, 60, 62, 64, 66).

3. The fuel cell system (2) according to claim 1, wherein a porous humidifying body (82), through which the oxidant flow passes, is arranged downstream of the at least one humidification connection (58, 60, 62, 64, 66) in order to promote the evaporation or vaporization of water.

4. The fuel cell system (2) according to claim 1, wherein a dosing unit (56) is arranged upstream of the at least one humidification connection (58, 60, 62, 64, 66) and is configured to discharge water in a dosed and pressurized manner into the at least one humidification connection (58, 60, 62, 64, 66).

5. The fuel cell system (2) according to claim 4, wherein the dosing unit (54) and/or the at least one humidification connection (58, 60, 62, 64, 66) comprises a spraying or misting apparatus (80) for spraying or misting the water.

6. The fuel cell system (2) according to claim 4, wherein the dosing unit (54) is connected to a buffer storage means (52, 78), in which water is at least temporarily collected.

7. The fuel cell system (2) according to claim 1, further comprising a control unit (76) configured to operatively connect with at least one dosing valve (54, 68) or a dosing unit (54) that is arranged upstream of the at least one humidification connection (58, 60, 62, 64, 66) and configured to discharge water in a dosed and pressurized manner into the at least one humidification connection (58, 60, 62, 64, 66), wherein the control unit (76) is configured to control a quantity of the water flowing into the oxidant line (34) as a function of an operating state of the at least one fuel cell (4).

8. The fuel cell system (2) according to claim 7, wherein the control unit (76) is configured to detect or determine the amount of water flowing into the oxidant line (34).

9. The fuel cell system (2) according to claim 1, wherein the fuel cell system (2) is configured to increase a pressure difference between the anode (6) and the cathode (8) during a predetermined time interval and to conduct water into the at least one humidification connection (58, 60, 62, 64, 66) during the time interval.

10. The fuel cell system (2) according to claim 1, wherein a cathode bypass (72) is provided which is configured to selectively connect the cathode outlet (44) to the oxidant line (34) in order to discharge excess water into the exhaust gas duct (48) or directly to the environment (24).
